(19) United States
(12) Patent Application Publication
(10) Pub. No.: US 2024/0029607 A1
(43) Pub. Date: Jan. 25, 2024

(54) DRIVE CIRCUIT, DATA-DRIVEN METHOD AND DISPLAY PANEL

(71) Applicants: HUIZHOU CHINA STAR OPTOELECTRONICS DISPLAY CO., LTD., Huizhou, Guanddong (CN); TCL CHINA STAR OPTOELECTRONICS TECHNOLOGY CO., LTD., Shenzhen, Guangdong (CN)

(72) Inventor: Qingsheng LAN, Huizhou, Guangdong (CN)

(73) Assignees: Huizhou China Star Optoelectronics Display Co., Ltd., Huizhou, Guangdong (CN); TCL China Star Optoelectronics Technology Co., Ltd., Shenzhen, Guangdong (CN)

(21) Appl. No.: 17/418,889

(22) PCT Filed: May 27, 2021
(86) PCT No.: PCT/CN2021/096479

§ 371 Date: Jun. 28, 2021

(30) Foreign Application Priority Data
Apr. 29, 2021 (CN) 202110471388.3

(51) Int. Cl. G09G 3/20

(52) U.S. Cl. CPC G09G 3/20; G09G 2310/0272; G09G 2330/021

(57) ABSTRACT

The present disclosure provides a drive circuit that comprises: an electrical module and an electrical sub-module connected to the electrical module. When the electrical sub-module detects that an input voltage and an output voltage of the electrical module are equal, an initial quiescent current of the electrical module is reduced, when there is a difference between the input voltage and the output voltage of the electrical module, the initial quiescent current of the electrical module is reduced after maintaining or increasing the initial quiescent current of the electrical module for a preset time period.

### FIELD OF THE DISCLOSURE

The present disclosure relates to a technical field of display panel, more particularly, to a drive circuit, a data-driven method and a display panel.

### BACKGROUND

With the vigorous development of the intelligent information society, people's demand for display technology has become increasingly urgent and extensive, and the requirements have become more stringent. The display technology of the panel industry has developed rapidly and has gradually matured. The flat panel display has the advantages of high definition, good image color, power savings, being light and thin, and being easy to carry, and has been widely used in various types of smart terminals, home theaters, etc., which has a broad market prospect. In order to meet market demand, displays are gradually developing towards large size and high resolution. The larger the panel size and the higher the resolution are, the load of the panel drive circuit also increases. The power consumption of the panel has become a concern and an urgent problem that need to be solved. The display panel in the related art cannot ensure the display quality of the display panel when reducing the power consumption of the display panel.

### SUMMARY

The present disclosure provides a drive circuit, a data-driven method and a display panel that can reduce power consumption of the display panel and at the same time ensure a display quality of the display panel.

The present disclosure provides a drive circuit that comprises: an electrical module and an electrical sub-module connected to the electrical module. When the electrical sub-module detects that an input voltage and an output voltage of the electrical module are equal, an initial quiescent current of the electrical module is reduced, when there is a difference between the input voltage and the output voltage of the electrical module, the initial quiescent current of the electrical module is reduced after maintaining or increasing the initial quiescent current of the electrical module for a preset time period.

Optionally, when the input voltage and the output voltage of the electrical module are equal, the initial quiescent current of the electrical module is reduced to a first quiescent current, the first quiescent current is 30% to 80% of the initial quiescent current.

Optionally, the first quiescent current is 50% of the initial quiescent current. Optionally, when there is the difference between the input voltage and the output voltage of the electrical module, the initial quiescent current of the electrical module is reduced to a second quiescent current after maintaining the initial quiescent current of the electrical module for the preset time period, the second quiescent current is 30% to 80% of the initial quiescent current.

Optionally, the second quiescent current is 50% of the initial quiescent current.

Optionally, when there is the difference between the input voltage and the output voltage of the electrical module, the initial quiescent current of the electrical module is reduced to the first quiescent current after the initial quiescent current of the electrical module is increased to a third quiescent current for the preset time period, the first quiescent current is 30% to 80% of the initial quiescent current, the third quiescent current is 110% to 150% of the initial quiescent current.

Optionally, the preset time period is from 0.5 μs to 2 μs.

Optionally, the electrical sub-module comprises a comparator and a control unit, the comparator is configured to compare whether there is the difference between the output voltage and the input voltage of the electrical module or not, when the input voltage and the output voltage of the electrical module are equal, the control unit is configured to control to maintain or increase the initial quiescent current of the electrical module for the preset time period, then reduce the initial quiescent current of the electrical module.

Optionally, the drive circuit comprises an interface receiving module, a data shift module, a data register module, a data latch module, a level conversion module and a digital/analog conversion module, output terminals of the interface receiving module and the data shift module are connected to an input terminal of the data register module, an output terminal of the data register module is connected to an input terminal of the data latch module, an output terminal of the data latch module is electrically connected to an input terminal of the level conversion module, an output terminal of the level conversion module is connected to an input terminal of the digital/analog conversion module, an output terminal of the digital/analog conversion module is electrically connected to an input of the electrical sub-module.

The present disclosure provides a data-driven method that comprises: detecting whether there is a difference between an input voltage and an output voltage of an electrical module or not; reducing an initial quiescent current of the electrical module when the input voltage and the output voltage of the electrical module are equal; and reducing the initial quiescent current of the electrical module after maintaining or increasing the initial quiescent current of the electrical module for a preset time period when there is the difference between the input voltage and the output voltage of the electrical module.

The present disclosure provides a display panel that comprises a pixel and a drive circuit to drive the pixel. The drive circuit comprises: an electrical module and an electrical sub-module connected to the electrical module. When the electrical sub-module detects that an input voltage and an output voltage of the electrical module are equal, an initial quiescent current of the electrical module is reduced, when there is a difference between the input voltage and the output voltage of the electrical module, the initial quiescent current of the electrical module is reduced after maintaining or increasing the initial quiescent current of the electrical module for a preset time period.

Optionally, when the input voltage and the output voltage of the electrical module are equal, the initial quiescent current of the electrical module is reduced to a first quiescent current, the first quiescent current is 30% to 80% of the initial quiescent current.

Optionally, the first quiescent current is 50% of the initial quiescent current.

Optionally, when there is the difference between the input voltage and the output voltage of the electrical module, the initial quiescent current of the electrical module is reduced to a second quiescent current after maintaining the initial quiescent current of the electrical module for the preset time period, the second quiescent current is 30% to 80% of the initial quiescent current.

Optionally, the second quiescent current is 50% of the initial quiescent current.

Optionally, when there is the difference between the input voltage and the output voltage of the electrical module, the initial quiescent current of the electrical module is reduced to the first quiescent current after the initial quiescent current of the electrical module is increased to a third quiescent current for the preset time period, the first quiescent current is 30% to 80% of the initial quiescent current, the third quiescent current is 110% to 150% of the initial quiescent current.

Optionally, the preset time period is from 0.5 μs to 2 μs.

Optionally, the preset time period is from 1 μs to 1.5 μs.

Optionally, the electrical sub-module comprises a comparator and a control unit, the comparator is configured to compare whether there is the difference between the output voltage and the input voltage of the electrical module or not, when the input voltage and the output voltage of the electrical module are equal, the control unit is configured to control to maintain or increase the initial quiescent current of the electrical module for the preset time period, then reduce the initial quiescent current of the electrical module.

Optionally, the drive circuit comprises an interface receiving module, a data shift module, a data register module, a data latch module, a level conversion module and a digital/analog conversion module, output terminals of the interface receiving module and the data shift module are connected to an input terminal of the data register module, an output terminal of the data register module is connected to an input terminal of the data latch module, an output terminal of the data latch module is electrically connected to an input terminal of the level conversion module, an output terminal of the level conversion module is connected to an input terminal of the digital/analog conversion module, an output terminal of the digital/analog conversion module is electrically connected to an input of the electrical sub-module.

The embodiments of the present disclosure provide the drive circuit, the data-driven method and the display panel. Through detecting whether there is the difference between the input voltage and the output voltage of the electrical module or not, the initial quiescent current of the electrical module is reduced when the input voltage and the output voltage of the electrical module are equal, so that the display panel operates in a low power consumption environment. When there is the difference between the input voltage and the output voltage of the electrical module, the initial quiescent current of the electrical module is maintained or increased for the preset time period. In this manner, the output driving force of the drive circuit can be improved to quickly charge the display panel, so that the display panel can save power consumption, and at the same time it is ensured that the panel can be fully charged when being charging. As a result, the display quality of the display panel is ensured.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structure diagram of a drive circuit according to one embodiment of the present disclosure.

FIG. 2 is a structural block diagram of a drive circuit according to one embodiment of the present disclosure.

FIG. 3 is a comparison diagram of power consumptions between a drive circuit according to one embodiment of the present disclosure and a drive circuit in the related art.

FIG. 4 is a schematic flowchart of the data-driven method according to one embodiment of the present disclosure.

FIG. 5 is a schematic structure diagram of a display panel according to one embodiment of the present disclosure.

### DESCRIPTION OF THE EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

It should be understood that, when an element or layer is referred to herein as being “disposed on”, “connected to” or “coupled to” another element or layer, it can be directly disposed on, connected or coupled to the other element or layer, or alternatively, that intervening elements or layers may be present. In contrast, when an element is referred to as being “directly disposed on,” “directly connected to” or “directly coupled to” another element or layer, there are no intervening elements or layers present. In the figures, like numbers refer to like elements throughout. As used herein, the term “and/or” includes any and all combinations of one or more of the associated listed items.

The present disclosure provides a drive circuit, a data-driven method and a display panel. Detailed descriptions are provided as follows. The order of descriptions of the following embodiments is not intended to limit the preferred order of the embodiments.

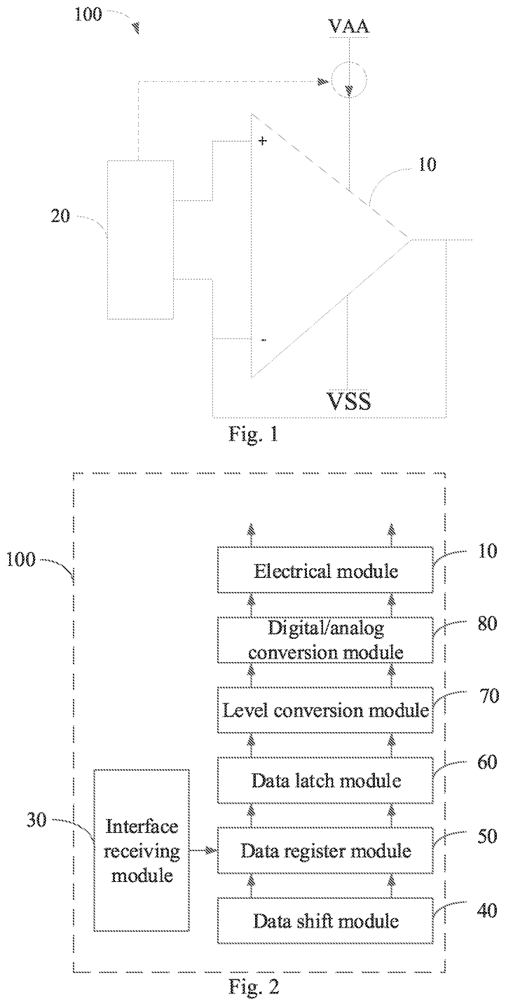

A description is provided with reference to FIG. 1. FIG. 1 is a schematic structure diagram of a drive circuit according to the present disclosure. A drive circuit 100 comprises an electrical module 10 and an electrical sub-module 20. The electrical sub-module 20 is connected to the electrical module 10. The electrical sub-module 20 is configured to detect whether there is a difference between an input voltage and an output voltage of the electrical module 10 or not. When the input voltage and the output voltage of the electrical module 10 are equal, an initial quiescent current of the electrical module is reduced. When there is the difference between the input voltage and the output voltage of the electrical module 10, the initial quiescent current of the electrical module is reduced to reduce power consumption of the drive circuit 100 after maintaining or increasing the initial quiescent current of the electrical module 10 for a preset time period.

In order to pursue low power consumption, a current display panel will reduce a quiescent current (I_bias) of the internal electrical module of the drive circuit 100. The I_bias current will directly affect a driving force of an output channel of the drive circuit 100 (a rise and fall time of the output channel). The larger the I_bias current is, the stronger the driving force of the output channel of the drive circuit 100, and the faster the rise and fall times. The smaller the I_bias current is, the weaker the driving force of the output channel of the drive circuit 100, and the slower the rise and fall times.

In order to reduce the power consumption of the drive circuit 100, reducing the I_bias current will cause the output driving force of the drive circuit 100 to become weaker, and the rise time and fall time of the output channel both slow down. Finally, the output channel of the drive circuit 100 is not able to fully charge the panel.

During a display process of a display panel, a grayscale voltage required for each grayscale is different. When the grayscale voltage needs to be increased, if the output driving force of the drive circuit 100 is insufficient, the rise time and fall time of the output channel will both slow down, and finally the output channel of the drive circuit 100 can not fully charge the panel. This will affect the display quality of the display panel. The present disclosure detects whether there is the difference between the input voltage and the output voltage of the electrical module 10 or not. When the input voltage and the output voltage of the electrical module 10 are equal, it means that the drive circuit 100 can drive the display panel to display while maintaining a low voltage, and the power consumption of the display panel can be saved at this time. When there is the difference between the input voltage and the output voltage of the electrical module 10, it means that the grayscale voltage needs to be increased. At this time, if the display panel is continuously driven under the condition of the low voltage, the output driving force of the drive circuit 100 is insufficient, and the rise time and fall time of the output channel both slow down. Finally, the output channel of the drive circuit 100 can not fully charge the panel. This will affect the display quality of the display panel. The present disclosure maintains or increases the initial quiescent current of the electrical module 10 for the preset time period, then reduces the initial quiescent current of the electrical module 10. In this manner, the output driving force of the drive circuit 100 can be improved during the process that the grayscale voltage is increased to quickly charge the display panel. This allows the display panel to save power consumption and at the same time ensures that the panel can be fully charged, thus ensuring the display quality of the display panel.

The electrical module 10 can amplify a data voltage input to the electrical module 10. The electrical sub-module 20 may comprise a comparator and a control unit. The comparator can be configured to compare whether there is the difference between the output voltage and the input voltage of the electrical module 10 or not. When the input voltage and the output voltage of the electrical module 10 are equal, the control unit can control to maintain or increase the initial quiescent current of the electrical module 10 for the preset time period, then reduces the initial quiescent current of the electrical module 10.

When the input voltage and the output voltage of the electrical module 10 are equal, the initial quiescent current of the electrical module 10 is reduced to a first quiescent current. The first quiescent current is 30% to 80% of the initial quiescent current.

When the input voltage and the output voltage of the electrical module 10 are equal, it means that the drive circuit 100 can drive the display panel to display while maintaining the low voltage. In order to reduce the power consumption of the display panel, the initial quiescent current of the electrical module 10 can be reduced to the first quiescent current. The first quiescent current may be 30% of the initial quiescent current, 40% of the initial quiescent current, 50% of the initial quiescent current, or 80% of the initial quiescent current, etc. In addition, when it is necessary to save the power consumption of the display panel, the initial quiescent current of the electrical module 10 can further be reduced to another ratio of the initial quiescent current.

When the input voltage and the output voltage of the electrical module 10 are equal, the initial quiescent current of the electrical module 10 is reduced to the first quiescent current. The first quiescent current is 50% of the initial quiescent current. In this manner, the power consumption of the drive circuit 100 can be reduced, and at the same time the output driving force will not be too weak, which in turn results in an excessively long charging time for the panel or failure to fully charge the panel.

When the input voltage and the output voltage of the electrical module 10 are equal, the extent to which the initial quiescent current of the electrical module 10 is reduced can be matched with a size of the display panel. In general, the larger the size of the display panel is, the smaller the extent to which the initial quiescent current of the electrical module 10 can be reduced. Conversely, the smaller the size of the display panel is, the greater the extent to which the initial quiescent current of the electrical module 10 can be reduced.

When there is the difference between the input voltage and the output voltage of the electrical module 10, the initial quiescent current of the electrical module 10 is reduced to a second quiescent current after maintaining the initial quiescent current of the electrical module 10 for the preset time period. The second quiescent current is 30% to 80% of the initial quiescent current.

When there is the difference between the input voltage and the output voltage of the electrical module 10, it means that the grayscale voltage needs to be increased. Maintaining the initial quiescent current of the electrical module 10 for the preset time period can improve the output driving force of the drive circuit 100 during the process that the grayscale voltage is increased to quickly charge the display panel. This allows the display panel to save power consumption and at the same time ensures that the panel can be fully charged by the drive circuit 100. After the panel is fully charged, the initial quiescent current of the electrical module 10 is reduced to the second quiescent current. The second quiescent current is 30% to 80% of the initial quiescent current. In this manner, the power consumption of the drive circuit 100 can be reduced. In order to reduce the power consumption of the display panel, the initial quiescent current of the electrical module 10 can be reduced to the second quiescent current. The second quiescent current is 30% of the initial quiescent current, 40% of the initial quiescent current, 50% of the initial quiescent current, or 80% of the initial quiescent current, etc. In addition, when it is necessary to save the power consumption of the display panel, the initial quiescent current of the electrical module 10 can further be reduced to another ratio of the initial quiescent current.

When there is the difference between the input voltage and the output voltage of the electrical module 10, the initial quiescent current of the electrical module 10 is reduced to the second quiescent current after maintaining the initial quiescent current of the electrical module 10 for the preset time period. The second quiescent current is 50% of the initial quiescent current. In this manner, the power consumption of the drive circuit 100 can be reduced, and at the same time the output driving force is not too weak, which in turn results in an excessively long charging time for the panel or failure to fully charge the panel.

When there is the difference between the input voltage and the output voltage of the electrical module 10, the initial quiescent current of the electrical module 10 is reduced to the first quiescent current after the initial quiescent current of the electrical module 10 is increased to a third quiescent current for the preset time period. The first quiescent current is 30% to 80% of the initial quiescent current. The third quiescent current is 110% to 150% of the initial quiescent current.

When there is the difference between the input voltage and the output voltage of the electrical module 10, the grayscale voltage needs to be increased. After increasing the initial quiescent current of the electrical module 10 to 110% to 150% of the initial quiescent current, the output driving force of the drive circuit 100 can become stronger during the process that the grayscale voltage is increased to quickly charge the display panel. This allows the display panel to save power consumption while ensuring that the drive circuit 100 can fully charge the panel. After the panel is fully charged, the initial quiescent current of the electrical module 10 is reduced to 30% to 80% of the initial quiescent current. In this manner, the drive circuit 100 can reduce power consumption. In order to reduce the power consumption of the display panel, the initial quiescent current of the electrical module 10 can be reduced to 30% of the initial quiescent current, 40% of the initial quiescent current, 50% of the initial quiescent current, or 80% of the initial quiescent current, etc. In addition, when it is necessary to save the power consumption of the display panel, the initial quiescent current of the electrical module 10 can further be reduced to another ratio of the initial quiescent current.

The preset time period is from 0.5 microseconds (μs) to 2 μs.

The preset time period may be 0.5 μs, 0.6 μs, 0.7 μs, 1 μs, 1.2 μs, 1.5 μs, or 2 μs, etc. It can be understood that the preset time period can be adjusted depending on the size of the display panel. Generally, the setting of the preset time period needs to meet the following requirement: when there is the difference between the input voltage and output voltage of the electrical module 10, the drive circuit 100 is able to charge the display panel to saturation after maintaining or increasing the initial quiescent current of the electrical module 10 for the preset time period.

A description is provided with reference to FIG. 2. FIG. 2 is a structural block diagram of a drive circuit according to the present disclosure. The drive circuit 100 comprises an interface receiving module 30, a data shift module 40, a data register module 50, a data latch module 60, a level conversion module 70 and a digital/analog conversion module 80. Output terminals of the interface receiving module 30 and the data shift module 40 are connected to an input terminal of the data register module 50. An output terminal of the data register module 50 is connected to an input terminal of the data latch module 60. An output terminal of the data latch module 60 is electrically connected to an input terminal of the level conversion module 70. An output terminal of the level conversion module 70 is connected to an input terminal of the digital/analog conversion module 80. An output terminal of the digital/analog conversion module 80 is electrically connected to an input of the electrical sub-module 20.

The interface receiving module 30 is configured to receive differential data and transmit the differential data to the data register module 50 in a form of serial signals. When the interface receiving module 30 transmits the serial signals to the data register module 50, the data shift module 40 sends a clock signal, so that the data is temporarily stored in the data register module 50 in a form of parallel signals. The data register module 50 transmits the stored data to the data latch module 60. The data latch module 60 stores the data input from the data register module 50. The level conversion module 70 is configured to increase a voltage level of the data stored in the data latch module 60. The digital/analog conversion module 80 is configured to convert a voltage input by the level conversion module 70 into a digital signal, and transmit the digital signal to the electrical module 10. The drive circuit 100 can convert a gamma voltage into a grayscale voltage.

The drive circuit 100 according to the present disclosure comprises the electrical module 10 and the electrical sub-module 20. The electrical sub-module 20 is connected to the electrical module 10. The electrical sub-module 20 is configured to detect whether there is the difference between the input voltage and the output voltage of the electrical module 10 or not. When the input voltage and the output voltage of the electrical module 10 are equal, the initial quiescent current of the electrical module 10 is reduced. When there is the difference between the input voltage and the output voltage of the electrical module 10, the initial quiescent current of the electrical module 10 is reduced to reduce the power consumption of the drive circuit 100 after maintaining or increasing the initial quiescent current of the electrical module 10 for the preset time period. Through detecting whether there is the difference between the input voltage and the output voltage of the electrical module 10 or not, the initial quiescent current can be adjusted. When the input voltage and the output voltage of the electrical module 10 are equal, the initial quiescent current of the electrical module 10 is reduced, so that the display panel operates in a low power consumption environment. When there is the difference between the input voltage and the output voltage of the electrical module 10, the initial quiescent current of the electrical module 10 is maintained or increased for the preset time period. In this manner, the output driving force of the drive circuit 100 can be improved to quickly charge the display panel, so that the display panel can save power consumption, and at the same time it is ensured that the panel can be fully charged when being charging. As a result, the display quality of the display panel is ensured.

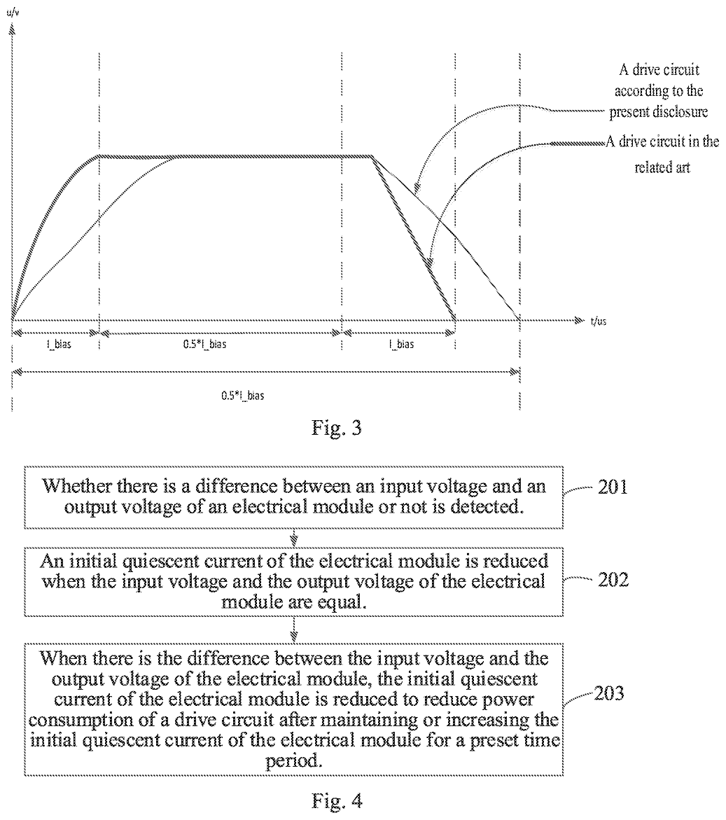

A description is provided with reference to FIG. 3. FIG. 3 is a comparison diagram of power consumptions between a drive circuit according to the present disclosure and a drive circuit in the related art. The drive circuit in the related art reduces the initial quiescent current of the electrical module to 0.5 times the initial quiescent current to continuously charge the display panel. When there is the difference between the input voltage and the output voltage of the electrical module, it means that the grayscale voltage required by the display panel has changed. At this time, 0.5 times the initial quiescent current is used to continuously charge the display panel. The method in the related art needs to spend too long a time during the voltage change process. Since the changing time of the grayscale voltage is very short, the drive circuit is unable to fully charge the display panel, thus resulting in a poor display quality. When there is the difference between the input voltage and the output voltage of the electrical module, the present disclosure maintains an input voltage of an initial power supply for the preset time period. The drive circuit 100 used in the present disclosure takes a shorter time during the changing process of the voltage. This can ensure that the display panel is fully charged during the changing process of the grayscale voltage to ensure the display quality of the display panel. During the process that the grayscale voltage does not change, the initial quiescent current of the electrical module is reduced to 0.5 times the initial quiescent current, and the display panel is continuously charged to reduce power consumption. Therefore, the use of the drive circuit 100 according to the present disclosure can reduce power consumption while ensuring the display quality of the display panel.

A description is provided with reference to FIG. 4. FIG. 4 is a schematic flowchart of the data-driven method according to the present disclosure. This present disclosure provides a data-driven method, and the data-driven method comprises the operations as follows:

201: Whether there is a difference between an input voltage and an output voltage of an electrical module or not is detected.

It is noted that the input voltage and the output voltage of the electrical module are first detected. A comparator is used to determine whether there is the difference between the output voltage and the input voltage of the electrical module or not. Of course, some other methods can be used to detect whether there is the difference between the input voltage and the output voltage of the electrical module or not, and a description in this regard is not provided.

202: An initial quiescent current of the electrical module is reduced when the input voltage and the output voltage of the electrical module are equal.

When the input voltage and the output voltage of the electrical module are equal, it means that a drive circuit can drive a display panel to display while maintaining a low voltage, and power consumption of the display panel can be saved at this time.

203: When there is the difference between the input voltage and the output voltage of the electrical module, the initial quiescent current of the electrical module is reduced after maintaining or increasing the initial quiescent current of the electrical module for a preset time period.

When there is the difference between the input voltage and the output voltage of the electrical module, it means that the grayscale voltage needs to be increased. At this time, if the display panel is continuously driven under the condition of the low voltage, the output driving force of the drive circuit is insufficient, and the rise time and fall time of the output channel both slow down. Finally, the output channel of the drive circuit can not fully charge the panel, which in turn affects the display quality of the display panel. The present disclosure maintains or increases the initial quiescent current of the electrical module for the preset time period, then reduces the initial quiescent current of the electrical module. In this manner, the output driving force of the drive circuit can be increased during the process that the grayscale voltage is increased to quickly charge the display panel. This allows the power consumption of the display panel to be saved and at the same time ensures that the panel can be fully charged by the drive circuit, thus ensuring the display quality of the display panel.

Due to the adoption of the data-driven method of the present disclosure, the output driving force of the drive circuit can be improved when the data-driven force needs to be increased to quickly charge the display panel. Hence, when the display panel saves power consumption, it can be ensured that the panel is fully charged to ensure the display quality of the display panel. At the same time, when there is no need to increase the data-driven force, the display panel can work in a low power consumption state.

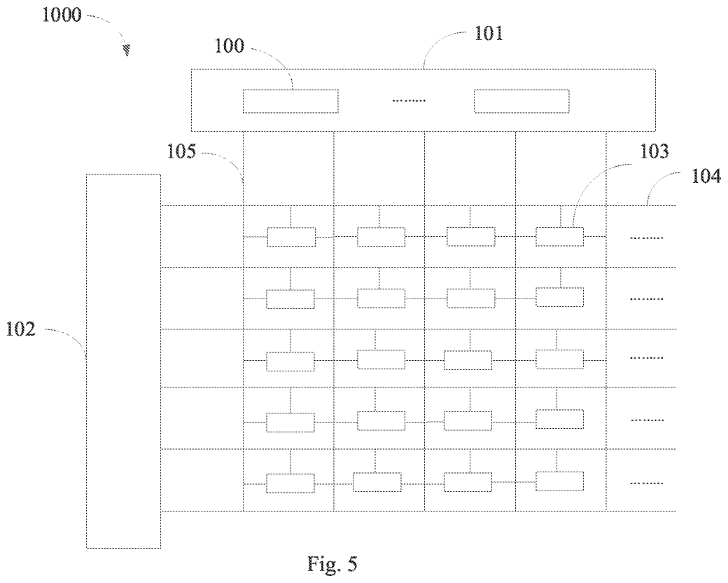

A description is provided with reference to FIG. 5. FIG. 5 is a schematic structure diagram of a display panel according to the present disclosure. The present disclosure provides a display panel 1000. The display panel 1000 comprises a data driver 101, a scan driver 102, and pixels 103. The data driver 101 comprises a plurality of drive circuits 100, and the data driver 101 is configured to drive data lines 105. The scan driver 102 is configured to drive scan lines 104. The data lines 105 and the scan lines 104 intersect to form pixel areas, and pixels 103 are disposed in the pixel areas. The data driver 101 and the scan driver 102 cooperatively drive the pixels 103 so that the pixels 103 emit light. The drive circuit 100 is the drive circuit 100 of the above embodiment. Since the drive circuit 100 has been described in detail in the foregoing embodiment, a description in this regard is not provided.

The display panel 1000 provided in this disclosure can be used in an electronic device that can be a smart phone, a tablet personal computer, a mobile phone, an e-book reader, a desktop personal computer, a laptop personal computer, a netbook computer, a workstation, a server, a personal digital assistant, a portable multimedia player, an MP3 player, a camera, a game machine, a video camera, a video navigation, an ATM or wearable device.

The display panel 1000 according to the present disclosure adopts the drive circuit 100. The drive circuit 100 detects whether there is the difference between the input voltage and the output voltage of the electrical module 10 to adjust the initial quiescent current of the electrical module 10. When the input voltage and the output voltage of the electrical module 10 are equal, the initial quiescent current of the electrical module 10 is reduced, so that the display panel 1000 operates in the low power consumption environment. When there is the difference between the input voltage and the output voltage of the electrical module 10, the initial quiescent current of the electrical module 10 is maintained or increased for the preset time period. In this manner, the output driving force of the drive circuit 100 can be improved to quickly charge the display panel 1000, so that the display panel 1000 can save power consumption, and at the same time it is ensured that the panel can be fully charged by the drive circuit 100. As a result, the display quality of the display panel is improved.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A drive circuit comprising:
an electrical module; and
an electrical sub-module connected to the electrical module;
wherein when the electrical sub-module detects that an input voltage and an output voltage of the electrical module are equal, an initial quiescent current of the electrical module is reduced, when there is a difference between the input voltage and the output voltage of the electrical module, the initial quiescent current of the electrical module is reduced after maintaining or increasing the initial quiescent current of the electrical module for a preset time period.

2. The drive circuit as claimed in claim 1, wherein when the input voltage and the output voltage of the electrical module are equal, the initial quiescent current of the electrical module is reduced to a first quiescent current, the first quiescent current is 30% to 80% of the initial quiescent current.

3. The drive circuit as claimed in claim 2, wherein the first quiescent current is 50% of the initial quiescent current.

4. The drive circuit as claimed in claim 1, wherein when there is the difference between the input voltage and the output voltage of the electrical module, the initial quiescent current of the electrical module is reduced to a second quiescent current after maintaining the initial quiescent current of the electrical module for the preset time period, the second quiescent current is 30% to 80% of the initial quiescent current.

5. The drive circuit as claimed in claim 4, wherein the second quiescent current is 50% of the initial quiescent current.

6. The drive circuit as claimed in claim 1, wherein when there is the difference between the input voltage and the output voltage of the electrical module, the initial quiescent current of the electrical module is reduced to the first quiescent current after the initial quiescent current of the electrical module is increased to a third quiescent current for the preset time period, the first quiescent current is 30% to 80% of the initial quiescent current, the third quiescent current is 110% to 150% of the initial quiescent current.

7. The drive circuit as claimed in claim 1, wherein the preset time period is from 0.5 μs is to 2 μs.

8. The drive circuit as claimed in claim 1, wherein the electrical sub-module comprises a comparator and a control unit, the comparator is configured to compare whether there is the difference between the output voltage and the input voltage of the electrical module or not, when the input voltage and the output voltage of the electrical module are equal, the control unit is configured to control to maintain or increase the initial quiescent current of the electrical module for the preset time period, then reduce the initial quiescent current of the electrical module.

9. The drive circuit as claimed in claim 1, wherein the drive circuit comprises an interface receiving module, a data shift module, a data register module, a data latch module, a level conversion module and a digital/analog conversion module, output terminals of the interface receiving module and the data shift module are connected to an input terminal of the data register module, an output terminal of the data register module is connected to an input terminal of the data latch module, an output terminal of the data latch module is electrically connected to an input terminal of the level conversion module, an output terminal of the level conversion module is connected to an input terminal of the digital/analog conversion module, an output terminal of the digital/analog conversion module is electrically connected to an input of the electrical sub-module.

10. A data-driven method comprising:
detecting whether there is a difference between an input voltage and an output voltage of an electrical module or not;
reducing an initial quiescent current of the electrical module when the input voltage and the output voltage of the electrical module are equal; and
reducing the initial quiescent current of the electrical module after maintaining or increasing the initial quiescent current of the electrical module for a preset time period when there is the difference between the input voltage and the output voltage of the electrical module.

11. A display panel, comprising a pixel and a drive circuit to drive the pixel, the drive circuit comprising:
an electrical module; and
an electrical sub-module connected to the electrical module;
wherein when the electrical sub-module detects that an input voltage and an output voltage of the electrical module are equal, an initial quiescent current of the electrical module is reduced, when there is a difference between the input voltage and the output voltage of the electrical module, the initial quiescent current of the electrical module is reduced after maintaining or increasing the initial quiescent current of the electrical module for a preset time period.

12. The display panel as claimed in claim 11, wherein when the input voltage and the output voltage of the electrical module are equal, the initial quiescent current of the electrical module is reduced to a first quiescent current, the first quiescent current is 30% to 80% of the initial quiescent current.

13. The display panel as claimed in claim 12, wherein the first quiescent current is 50% of the initial quiescent current.

14. The drive circuit as claimed in claim 11, wherein when there is the difference between the input voltage and the output voltage of the electrical module, the initial quiescent current of the electrical module is reduced to a second quiescent current after maintaining the initial quiescent current of the electrical module for the preset time period, the second quiescent current is 30% to 80% of the initial quiescent current.

15. The display panel as claimed in claim 14, wherein the second quiescent current is 50% of the initial quiescent current.

16. The display panel as claimed in claim 11, wherein when there is the difference between the input voltage and the output voltage of the electrical module, the initial quiescent current of the electrical module is reduced to the first quiescent current after the initial quiescent current of the electrical module is increased to a third quiescent current for the preset time period, the first quiescent current is 30% to 80% of the initial quiescent current, the third quiescent current is 110% to 150% of the initial quiescent current.

17. The display panel as claimed in claim 11, wherein the preset time period is from 0.5 μs to 2 μs.

18. The display panel as claimed in claim 11, wherein the preset time period is from 1 μs to 1.5 μs.

19. The display panel as claimed in claim 11, wherein the electrical sub-module comprises a comparator and a control unit, the comparator is configured to compare whether there is the difference between the output voltage and the input voltage of the electrical module or not, when the input voltage and the output voltage of the electrical module are equal, the control unit is configured to control to maintain or increase the initial quiescent current of the electrical module for the preset time period, then reduce the initial quiescent current of the electrical module.

20. The display panel as claimed in claim 11, wherein the drive circuit comprises an interface receiving module, a data shift module, a data register module, a data latch module, a level conversion module and a digital/analog conversion module, output terminals of the interface receiving module and the data shift module are connected to an input terminal of the data register module, an output terminal of the data register module is connected to an input terminal of the data latch module, an output terminal of the data latch module is electrically connected to an input terminal of the level conversion module, an output terminal of the level conversion module is connected to an input terminal of the digital/analog conversion module, an output terminal of the digital/analog conversion module is electrically connected to an input of the electrical sub-module.
